(19) United States
(12) Patent Application Publication
(10) Pub. No.: US 2024/0424423 A1
(43) Pub. Date: Dec. 26, 2024

(54) DEHYDRATION METHOD FOR CARBONACEOUS MATERIAL DISPERSION ELEMENT AND METHOD FOR PRODUCING CARBONACEOUS MATERIAL DISPERSION ELEMENT

(71) Applicant: REFINE HOLDINGS CO., LTD., Gifu (JP)

(72) Inventors: Kensuke FUKASAWA, Tokyo (JP); Tomokiyo TAKEYAMA, Tokyo (JP); Masaru NAKAJO, Tokyo (JP); Takao SUZUKI, Tokyo (JP)

(73) Assignee: REFINE HOLDINGS CO., LTD., Gifu (JP)

(21) Appl. No.: 18/566,445

(22) PCT Filed: Jun. 3, 2022
(86) PCT No.: PCT/JP2022/022569

§ 371 Date: Jun. 20, 2024

(30) Foreign Application Priority Data
Jun. 4, 2021 (JP) 2021-094798

(51) Int. Cl. B01D 1/14; C09C 1/56; H01M 4/139; H01M 4/62; H01M 10/0525

(52) U.S. Cl. CPC B01D 1/14; C09C 1/56; H01M 4/139; H01M 4/622; H01M 4/625; H01M 10/0525

(57) ABSTRACT

Provided is a method for easily and quickly removing water from a carbonaceous material dispersion without impairing the stability of the dispersion. A method for dehydrating carbonaceous material dispersion in which carbonaceous material particles are dispersed in an organic dispersing medium, the method being characterized in that it has a process in which a dry inert gas of 6 to 30 L relative to 100 g of the dispersion is blown into the dispersion maintained at 20 to 120° C., and the dispersion is brought into contact with the dry inert gas so that the water in the dispersion is evaporated.

### TECHNICAL FIELD

### Cross-Reference

This application claims priority of Japan Patent Application No. 2021-94798 filed in Japan on Jun. 4, 2021, and the entire contents of that application are incorporated herein by reference. In addition, the contents of all patents, patent applications, and documents cited in this specification are incorporated herein by reference in their entirety.

The present invention relates to a method for dehydrating a carbonaceous material dispersion and a method for manufacturing a carbonaceous material dispersion. In detail, the present invention relates to a method for dehydrating a carbonaceous material dispersion, in which water is removed from carbonaceous material dispersion for all-solid-state batteries in which carbonaceous material particles are dispersed in an organic dispersion medium, and a method for manufacturing a carbonaceous material dispersion.

### BACKGROUND TECHNOLOGY

In lithium-ion batteries, an electrolytic solution has been used as a medium to move ions, but since problems such as leakage, fire, and explosion may occur in batteries using such the electrolytic solution, all-solid-state lithium-ion rechargeable batteries are being developed that use a solid electrolyte instead of a liquid electrolyte, as well as all other elements in solid form. The all-solid-state lithium-ion secondary battery has a very low charge transfer resistance between the solid electrolyte and lithium ions, which reduces the internal resistance of the battery, and since the electrolyte is solid, there is little risk of fire, no leakage, and little degradation of battery performance due to corrosion.

The all-solid lithium-ion secondary battery has cathode layer, an anode layer, and a solid electrolyte layer disposed between them, the electrolyte comprising a solid.

As a solid electrolyte layer, in the case where only the electrode active material is used and the electrode layer is manufactured by powder molding, since the electrolyte is solid, it is difficult for the electrolyte to penetrate into the interior of the electrode layer, and the interface between the electrode active material and the electrolyte is reduced, resulting in reduced battery performance. In addition, since the electrode layer is composed of solid, it lacks flexibility and workability, resulting in poor handling.

In response to such a problem, a scheme for forming an electrode layer using a slurry prepared by dispersing an electrode active material, a solid electrolyte material, and a binder in a solvent has been proposed.

In conventional lithium-ion batteries, an electrode slurry in which active materials and conductive auxiliary agents are dispersed in a polymer solution of polyvinylidene fluoride (PVDF) as a binder in N-methyl-2-pyrrolidone (NMP) solvent, or another electrode slurry in which active materials and conductive auxiliary agents are dispersed in an aqueous solution of styrene butadiene rubber (SBR) emulsified as a binder in a water solvent, and thickening agents such as carboxymethyl cellulose (CMC) are added, is used. But with regard to all-solid-state lithium-ion batteries, if the solid electrolyte is exposed to highly polar solvents, ionic conductivity is reduced and adequate battery performance cannot be obtained, and therefore it is not preferable to use NMP or water as a solvent for electrode slurry for electrode fabrication, and instead, a low-polarity or nonpolar solvent is used.

Further, as described above, water in the solid electrolyte reduces ionic conductivity and can also cause hydrolysis of other materials constituting the solid electrolyte. It is therefore required that the dispersion of carbonaceous material used in the manufacture of the all-solid battery contain as little moisture as possible.

One way to obtain low-moisture carbonaceous material dispersions is to keep the water content of each material itself as low as possible in preparing the carbonaceous material dispersion.

For example, as a method of removing water from a non-aqueous solvent, methods of using ion exchange resins as described in Patent Literature 1, methods of using zeolites as described in Patent Literatures 2 and 3, methods of treating with at least one species selected from the group consisting of fluorophosgene, phosgene and phosgene dimer, and treating with metal oxides as shown in Patent Literature 4, are known. There are also several methods of dehydration, such as heating and distillation dehydration or azeotropic dehydration, which are common methods of polymer dehydration as shown in Patent Document 5, reducing viscosity with an auxiliary solvent and dehydrating with a dehydration adsorbent, and dehydrating by distillation, and the like. It is conceivable that these methods apply to the dehydration treatment of carbonaceous material dispersions.

However, dehydration methods that use dehydration adsorbents like molecular sieves and alumina particles can result in undesirable electrochemical effects. This is due to various reasons such as the presence of residual auxiliary solvents that are used to reduce viscosity, the addition of impurities from molecular sieves and alumina particles, the adhesion and residue of these particles on the electrolyte, cathode surface, and separator, the possibility of removing essential components by adsorbing components other than water, and the lack of a significant reduction in the rate of water, etc.

In addition, in the dehydration methods using such an adsorbent, for example, in the case where the water content of a dispersion is 1000 ppm, if the dispersion is dehydrated to, for example, less than 50 ppm of water by using only the adsorbent, a large amount of the adsorbent is required for the dispersion, and the time required for the dehydration is also very long, which is inefficient.

In addition, in Patent Literature 6, it is proposed to add a solid dehydrating agent such as zeolite, silica gel, etc., or dehydrating agent such as phosphate esters, phosphine oxide, ortho-esters, acid anhydrides, etc., in the manufacturing process of conductive paste for lithium-ion battery cathodes, and also to prevent moisture contamination by conducting the manufacturing process in a low dew-point environment, for example.

However, as mentioned above, there are problems with the use of a dehydrating agent, and in the case of a manufacturing process under a low dew point environment, it is necessary to introduce a glove box or a drying room or the like. Furthermore, a pretreatment process is required to remove the water contained in all materials in advance, including the dispersant, and manufacturing in a glove box or dry room is not easy to work with.

Further, as a method of removing water from an aqueous solvent, as shown in Patent Literature 7 and 8, methods are known for evaporating, removing water from a solvent by blowing a dry inert gas into the liquid. However, all of the methods disclosed in these documents were applied to solvents or solutions, and it was unclear whether they could be applied to carbonaceous material dispersions in which particles tend to agglomerate.

However, the methods disclosed in these documents are applicable to solvents or solutions, and it is not clear whether they are applicable to dispersions of carbonaceous materials in which particles tend to agglomerate.

### PRIOR ART REFERENCES

### Patent Literature

[Patent Literature 1] JP SHO 56(1981)-60648A
[Patent Literature 2]: JP HEI 7(1995)-235309A
[Patent Literature 3] JP 2011-71111A
[Patent Literature 4] JP 2001-297791A
[Patent Literature 5] JP HEI 11(1999)-217350A
[Patent Literature 6] JP 2018-6337A
[Patent Literature 7] JP SHO 50(1975)-29472A
[Patent Literature 8] JP HEI 10(1998)-338653A

### SUMMARY OF INVENTION

### Problem to be Solved

Accordingly, the subject matter of the present invention is to provide a method for dehydrating a carbonaceous material dispersion and a method for manufacturing the carbonaceous material dispersion, both of which solve the above problems. The subject matter of the present invention is also to provide a method of dehydrating a carbonaceous material dispersion and a method for manufacturing a carbonaceous material dispersion, both of which provide carbonaceous material dispersion with low water content that can inhibit degradation of the solid electrolyte when used as a conductive auxiliary agent for an all-solid lithium-ion secondary battery, easily and quickly, and without impairing the stability of the dispersion.

### Means for Solving the Problem

The present invention, which addresses the above subject matter, is a method for dehydrating a dispersion of carbonaceous material in which carbonaceous material particles are dispersed in an organic dispersing medium, and is characterized in that it has a process in which a dry inert gas of 6 to 30 L relative to 100 g of the dispersion is blown into the dispersion maintained at 20 to 120° C., and the dispersion is brought into contact with the dry inert gas so that the water in the dispersion is evaporated.

In an embodiment of the method of dehydrating a carbonaceous material dispersion according to the present invention, the carbonaceous material dispersion is stirred while blowing the inert gas through it, and the inert gas is blown from a bottom side of a container that contains the carbonaceous material dispersion.

In another embodiment of the method of dehydrating a carbonaceous material dispersion according to the present invention, bubbles with an average size ranging from 5 mm to 0.5 mm are generated in the carbonaceous material dispersion by blowing said inert gas into the dispersion.

In one embodiment of the method of dehydrating a carbonaceous material dispersion according to the present invention, when the inert gas is blown in, the pressure in the system is reduced to −5 kPa to −95 kPa in comparison to atmospheric pressure.

In one embodiment of the method of dehydrating a carbonaceous material dispersion according to the present invention, the gas in the dispersion is degassed by reducing the pressure after the inert gas is blown in.

In one embodiment of the method of dehydrating a dispersion of a carbonaceous material of the present invention, the organic dispersing medium is at least one selected from the group consisting of ester solvents, ketone solvents, hydrocarbon solvents, and mixtures thereof.

In one embodiment of the method of dehydrating a dispersion of a carbonaceous material of the present invention, the organic dispersing medium is at least one selected from the group consisting of butyl butyrate, xylene, mesitylene, and heptane.

In one embodiment of a method of dehydrating a carbonaceous material dispersion according to the present invention, the carbonaceous material is carbon black.

In one embodiment of the method of dehydrating a carbonaceous material dispersion according to the present invention, the inert gas is nitrogen.

In one embodiment of the method of dehydrating a carbonaceous material dispersion according to the present invention, the inert gas has a dew point of −50° C. or less.

In one embodiment of the method of dehydrating a carbonaceous material dispersion according to the present invention the carbonaceous material dispersion comprises a carbonaceous material, an organic dispersing medium, and a dispersant.

In one embodiment of the method of dehydrating a carbonaceous material dispersion according to the present invention, the carbonaceous material dispersion is an electrode slurry for an all-solid lithium-ion secondary battery comprising a carbonaceous material, an organic dispersing medium, a dispersant, a binder resin, and a cathode active material or an anode active material.

In one embodiment of the method of dehydrating a carbonaceous material dispersion according to the present invention, the change in a non-volatile component of the dispersion before and after contacting the dispersion with the dry inert gas to evaporate the water in the dispersion is not more than 0.5% by mass, and the water content of the dispersion after the contacting is not more than 5×10⁻⁵ in terms of mass fraction.

The present invention for solving the above subject matter is also a method for manufacturing a carbon material dispersion in which carbon material particles are dispersed in an organic dispersing medium, characterized in that it has a process in which carbon material particles is added to an organic dispersing medium and dispersed them to make a carbon material dispersion, and then a dry inert gas of 6 to 30 L relative to 100 g of the dispersion is blown into the dispersion maintained at 20 to 120° C., and the dispersion is brought into contact with the dry inert gas so that the water in the dispersion is evaporated.

In one embodiment of a method for manufacturing a carbonaceous material dispersion according to the present invention, the carbonaceous material dispersion comprises a carbonaceous material, an organic dispersing medium, and a dispersant.

In an embodiment of a method for manufacturing a carbonaceous material dispersion according to the present invention, the carbonaceous material dispersion is an electrode slurry for an all-solid lithium-ion secondary battery comprises a carbonaceous material, an organic dispersing medium, a dispersant, a binder resin, and a cathode active material or an anode active material.

### Effect of Invention

According to the present invention, since most low-polar or non-polar solvents used as solvents for electrode slurry for solid electrolyte electrode fabrication, such as esters represented by butyl butyrate, ketones represented by methyl isobutyl ketone, non-water-soluble aromatic substances such as xylene, toluene, and hydrocarbons such as heptane, cyclohexane, and the like, have an azeotrope with water, water can also be evaporated when the hydrocarbon substance evaporates. Even solvents that do not have an azeotropic point can be sufficiently dehydrated by aeration with dry gas, since solvents with a higher boiling point than water are often used for work environment reasons. Therefore, adequate dehydration can be achieved by drying gas aeration without the need for pre-treatment processes and separation and removal of additives or consumables that are difficult to separate and remove, making it possible to provide carbonaceous material dispersions with low water content in a simple manner, quickly, and without impairing the stability of the dispersion.

In addition, by making the carbonaceous material dispersion low-moisture, it is possible to contribute to the improvement of the stability and properties of the dispersion. In addition, when the carbonaceous material dispersion with low moisture obtained in this way is used as a conductive auxiliary agent for all-solid-state lithium-ion secondary batteries, the deterioration of the solid electrolyte can be suppressed, and the carbonaceous material is dispersed in a high concentration and homogeneously, and the solid component can be dispersed in a high concentration with a low viscosity when it is mixed with the electrode active material, so that it is possible to manufacture secondary batteries with excellent charging and discharging characteristics, cycling characteristics, and conductive electrodes that are stable in their properties.

### BRIEF DESCRIPTION OF THE DRAWING

FIG. 1 is an outline diagram schematically illustrating a dehydrating treatment device that can be used in one embodiment of the method for dehydrating a carbonaceous material dispersion according to the present invention.

### EMBODIMENT FOR CARRYING OUT THE INVENTION

Hereinafter, the present invention is described in detail based on the embodiments.

### <Method for Dehydrating Carbonaceous Material Dispersions>

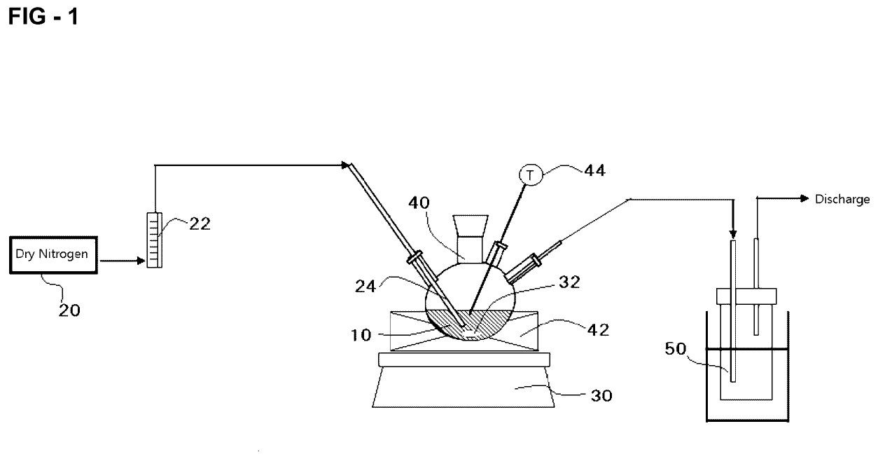

FIG. 1 is an outline diagram schematically illustrating a dehydrating treatment device that may be used in one embodiment of the method for dehydrating a carbonaceous material dispersion according to the present invention.

The present invention according to a first aspect is a method for dehydrating a carbon material dispersion 10 in which carbon material particles are dispersed in an organic dispersing medium (hereinafter also referred to as the “method for removing water of the present invention”), and is characterized in that it has a process in which a dry inert gas 20 is blown into the dispersion 10 which is maintained at a temperature of 20 to 120° C., in a volume of 6 to 30 L relative to a dispersion 100 g, so that the dispersion comes into contact with the dry inert gas to evaporate the water in the dispersion.

By setting the temperature of the dispersion at the time of treatment to 20 to 120° C., water can be removed by the inert gas which is effectively in contact with the dispersion without adversely affecting the composition, the physical properties and the characteristics of the dispersion, and the properties of the ingredients in the dispersion. To some extent, it depends on the type of organic dispersing medium used for the dispersion, but as the temperature of the dispersion, it is more preferably about 30 to 90° C., and even more preferably about 40 to 60° C.

It should be noted that heating the dry inert gas for blowing can also be considered, but it is less efficient.

In addition, by setting the volume of dry inert gas to be blown into the dispersion to 6 to 30 L per 100 g of the dispersion with a water content of 1×10⁻³ to 1×10⁻² in terms of mass fraction, water can be sufficiently removed without significantly affecting the composition of the dispersion.

If the venting volume of the dry inert gas is less than necessary, it is difficult to remove water effectively. On the other hand, if it is more than necessary, the amount of organic dispersing medium removed from the dispersion becomes large, and it is possible to change the composition of the dispersion (non-volatile components) to more than necessary.

It should be noted that the above venting volume of the dry inert gas is the volume at ambient temperature and pressure, and in this specification, “ambient temperature and pressure” means, for example, a condition in the range of 10 to 30° C., 96 kPa to 105 kPa, and typically, in particular, a condition of a temperature of 23° C. and a pressure of 101.325 kPa (1 atmosphere).

It is to be noted that, although there is no particular limitation, in one embodiment of the method for removing water of the present invention, the dispersion 10 is brought into contact with a dry inert gas 20 as described above, and the water in the dispersion is evaporated with a small amount of an organic dispersion medium, provided that the change in the non-volatile component of the dispersion before and after the treatment process is 0.5% by mass or less, more preferably 0.1% by mass or less, and the water content of the dispersion after the treatment process is not more than 5×10⁻⁵ in terms of mass fraction, more preferably not more than 2×10⁻⁵ in terms of mass fraction, and further preferably not more than 1×10⁻⁵ in terms of mass fraction.

In the water removal method of the present invention, the less the water content of the treated dispersion is, the more preferable it is, but if the organic dispersing medium in the dispersion is removed by an inert gas to more than necessary, and the composition of the dispersion and the change in the nonvolatile composition of the dispersion are changed to more than necessary, it is possible to produce a change in the state of dispersion in the dispersion, a rise in the viscosity, and a coagulation of dispersed matter, etc. But, in the water removal method of the present invention, even if the water content of the dispersion after treatment is sufficiently dehydrated to a mass fraction of 5×10⁻⁵ or less, the change in the nonvolatile components of the dispersion before and after the treatment process stays, representatively, at 0.5% by mass or less. Thus, it is preferable. It is also possible to consider a method in which an organic dispersion medium is added to the residue in advance so that the water is removed by evaporating the excessively added organic dispersion medium together with the water, but it is not recommended in terms of the environmental load due to the utilization of the excess organic substance and the increase in the emission of exhaust gases.

It should be noted that the change in non-volatile components of the dispersion before and after the treatment process can be calculated based on the weight of the residue after drying at 140° C. In addition, the water content of the dispersion can be implemented, for example, by using a Karl Fischer moisture titrator or a near-infrared absorbance trace moisture concentrator, a refractive index type concentrator, or the like. Alternatively, it can be implemented with higher precision by gas chromatography using an ionic liquid column.

In an embodiment shown in FIG. 1, a carbonaceous material dispersion 10 is held in a processing vessel (flask) 40 that is sealed except for the inlet and outlet paths of the inert gas 20, and dry nitrogen gas as the dry inert gas 20 is blown into the carbonaceous material dispersion 10 at a predetermined flow rate from a blowing nozzle 24 whose opening is located at the bottom side of the processing vessel 40 containing the carbonaceous material dispersion, while the flow rate is measured by a gas flow meter 22.

The outer periphery of the processing vessel 40 is surrounded by a heating jacket (mantle heater) 42 for heating the carbonaceous material dispersion housed inside the processing vessel, and by measuring the temperature of the carbonaceous material dispersion 10 with a liquid thermometer 44 and acting on this heating jacket 42 as needed, the temperature of the carbonaceous material dispersion 10 is maintained at a prescribed temperature during the water removal treatment.

In addition, a magnetic stirrer 30 is provided in the lower portion of the processing vessel 40, and a stirrer 32 is configured in the interior of the processing vessel 40. By carrying out these operations as needed, the efficiency of contacting the inert gas 20 introduced into the carbonaceous material dispersion 10 during the water removal treatment with the dispersion is improved, and at the same time, the dispersed state of the carbonaceous material in the carbonaceous material dispersion 10 is maintained.

An inert gas 20 is passed through the carbonaceous material dispersion 10 to transfer water from the dispersion 10 to the inert gas 20. The gas phase is moved further up in the dispersion 10 in the processing vessel 40, but the inert gas 20 may be accompanied by a small amount of organic dispersing media. Thus, the inert gas 20 is discharged out of the system after passing through a capture trap 50 that allows it to pass through the water phase and remove the accompanying constituents.

It is to be noted that in the method for removing water of the present invention, as a dehydrating treatment device that can be used, it is not limited to the laboratory-scale device shown in FIG. 1 as long as it is a device capable of blowing a dry inert gas 20 at a prescribed flow rate into the carbonaceous material dispersion 10 maintained at a prescribed temperature in accordance with the method of the present invention. For example, it is possible to have a continuous device instead of an intermittent one, and of course, it is also possible to have a complete-scale device corresponding to an industrial production scale.

Further, as each structure, in the device shown in FIG. 1, an inert gas 20 is blown into the dispersion from the nozzle 24 having an opening at the bottom side of the processing vessel 40 holding the carbonaceous material dispersion 10, and the magnetic stirrer 30 is utilized to stir the dispersion to improve the efficiency of gas-liquid contact, but there is no restriction as to the stirring device for the dispersion, and it is possible to use any well-known device such as a stirring device having various stirrers and a stirring device having a flow path structure without stirrers.

In addition, by blowing the inert gas into the dispersion in the form of fine bubbles instead of the nozzle 24 for introducing the inert gas 20, and by using a diffuser constructed of various porous bodies or porous grooves or the like, or by applying pressure waves generated by ultrasonic vibration directly to the liquid after introducing the inert gas, or the like, it is possible to adequately remove water without the stirring device described above even if it is not equipped with a stirring device as described above. Of course, it is also possible to use a stirring device as described above in conjunction with the method of blowing the inert gas into the dispersion in the state of fine bubbles.

In the case where the inert gas is introduced in the state of fine bubbles, there is no special limitation on “fine bubbles”, but, for example, it is preferable to have bubbles with a number average particle diameter of about 5 mm to 0.5 mm. In the case of bubbles having a number average particle diameter of about 5 mm to 0.5 mm, or more preferably about 3 to 1 mm, the bubbles can be present in the carbonaceous material dispersion with a sufficient retention time and effective contact efficiency to remove water.

It should be noted that the smaller the bubble diameter is, the more efficient the contact with the dispersion is, but on the other hand, if the bubble diameter is extremely small, excess energy for making small bubbles is required, and furthermore, in the dispersion, especially at the interface between the carbonaceous material particles and the organic dispersion medium or the like, the bubbles are retained or left for a long period of time, and there is a possibility that they will not be able to act as a dehydrating agent. Further, there is the possibility of the dispersion becoming a state of gas entrapped and the characteristics of the dispersion may be reduced.

Here, the number average particle diameter of bubbles can be obtained from an image taken by a high-speed camera.

Since the carbonaceous material dispersion 10, which is the material to be treated, has a pitch-black appearance and it is difficult to observe bubbles from the image, a transparent pseudo-substance with the same viscosity and surface tension as the carbonaceous material dispersion was used to determine the number average particle diameter of bubbles in this specification. The number average particle diameter of bubbles was calculated from 1000 images taken in 1-second increments with a GX-1 camera (NAC) at a position 20 mm from the outlet of the bubble generator under the condition of an exposure time of 50 μs. Specifically, One bubble that was centered and in focus was selected out of each photograph, and the bubble diameter was measured. At this time, the focus was kept fixed and the length of the in-focus area was calculated from the scale. After performing the above operations on 1,000 photographs, the bubble diameters were averaged and the number average particle size was calculated.

In order to allow the inert gas 20 introduced into the carbonaceous material dispersion 10 to escape from the carbonaceous material dispersion 10 into the gas phase together with moisture without retarding the gas more than necessary, the pressure in the system can be reduced to −5 kPa to −95 kPa compared to atmospheric pressure, although the pressure is not particularly limited to the above.

Alternatively, it is also possible to perform a depressurization after blowing in an inert gas to degas the gas in the dispersing medium. The depressurization in this case is, for example, appropriately depressurized by about −5 kPa to −95 kPa compared to atmospheric pressure.

Also, in an embodiment shown in FIG. 1, the inert gas 20 derived from the processing vessel 40 is discharged outwardly of the system after passing through the trap 50, but it is also possible to recycle the inert gas, for example, by implementing an appropriate drying treatment that allows the inert gas to pass through a molecular sieve or a dehydrating membrane, etc., after passing through the trap 50.

Furthermore, in an embodiment shown in FIG. 1, an example of using nitrogen as the inert gas 20 is illustrated, but there is no special restriction on the use of an inert gas as long as it is a gas that substantially does not produce a chemical change in the carbonaceous material dispersion through contact and is capable of dehydrating the carbonaceous material dispersion, and, for example, argon, helium, neon, and the like, may be used in addition to nitrogen. However, as an inert gas, nitrogen is preferred from the viewpoint of economy and environmental friendliness.

In addition, there is no special limitation on the “dryness” of the dry inert gas 20 used in the present invention as long as the water content is at least less than that of the carbonaceous material dispersion to be treated, and the water can be effectively removed, such as when the dew point is −50° C. or less, and more preferably when the dew point is −60° C. or less.

Next, the carbonaceous material dispersion that is the object of treatment in the water removal method of the present invention is described.

### (Carbonaceous Material Dispersion)

There is no special restriction on the carbonaceous material dispersion that is the object of treatment, as long as it is a substance that disperses carbonaceous material particles in an organic dispersion medium.

### (Carbonaceous Materials)

As the carbonaceous material included in the carbonaceous material dispersion, there is no special limitation as long as the material is capable of forming a dispersion in an organic dispersion medium and can assume a powdery granular form. Typically, for example, graphite, carbon black (CB), carbon nanotubes (CNT), carbon nanofibers (CNF), carbon fibers (CF), fullerenes, natural graphite, and the like are enumerated, and they can be used individually or in combination of more than two kinds. As the carbonaceous material, CB is particularly preferred. Further, as the CB, there are listed, for example, furnace black, channel black, acetylene black, thermal black, and the like, and any one of them may be used. Among them, acetylene black, for example, is preferably blended into a carbon material dispersion for use in a secondary battery because the content of metal content in its production method is originally low.

In addition, the carbon black which is usually oxidized or graphitized may also be used as CB. The oxidation treatment of the carbon black is to treat the carbon black at high temperature in air, or to treat the carbon black with nitric acid, nitrogen dioxide, ozone, and the like, for example, to directly introduce (covalently bind) oxygen-containing polar functional groups such as phenol group, quinone group, carboxyl group and carbonyl group to a surface of the carbon black, so as to improve the dispersibility of the carbon black.

In this specification, there is no special restriction on the form of “powdered particles” of the carbonaceous material as long as it is possible to form a homogeneous dispersion in the dispersing medium by dispersion treatment. For example, it is possible to include primary particles with an average particle size of about 10 to 60 nm, secondary particles with an average particle size of about 1 to 1,000 μm due to agglomeration of such primary particles, etc., or particles with an average particle size of about 0.5 to 5 mm that are further processed by compression and granulation. Further, the shape is also not particularly limited, and is not limited to a substantially spherical shape, and it the shape is not limited to a substantially spherical shape, and it may include an oval shape, a flake shape, a needle shape or a short fiber shape, an amorphous shape, and the like. Carbonaceous material with an average particle size of 0.5 mm or more to 5 mm or less is more preferable. After preparation of the carbonaceous material dispersion by dispersion processing in a dispersing medium, it is desirable that the average particle size of the carbonaceous material in the dispersing medium is about 10 μm or less.

It should be noted that, in this specification, “average particle size” refers to a volume-based average particle size d50 (so-called median particle size) measured using a laser diffraction scattering particle size distribution measuring device.

In addition, regarding the carbon black, for example, as explained in the website of Carbon Black Association (https://carbonblack.biz/index.html), a smallest unit of the carbon black that cannot be decomposed is aggregate (primary aggregate), a part (domain) of which is usually called particle. This particle is considered as the smallest unit particle in nanomaterials, but is only a part of the aggregate. The aggregate forms an agglomerate (secondary aggregate) through physical forces such as intermolecular force (van der Waals force). Moreover, in order to prevent dispersion and improve operability, carbon black products are mostly transported and sold in the form of processed particles such as liquid beads gained through compression treatment and granulation treatment.

For example, the carbon black products may include a primary aggregate with an average particle size of about 10 to 100 nm, a secondary aggregate with an average particle size of about 0.1 to 100 μm, or processed particles with an average particle size of about 500 to 5,000 μm, which are formed by compression treatment and granulation treatment in further consideration of operability.

In addition, from the point of view of the conductivity of the carbon black, conductive carbon particles are preferably aggregates with chain or cluster structures formed by connecting primary particles to a certain extent. The connection of the primary particles of the aggregate, also known as tissue, may be measured by particle size distribution (dynamic light scattering method or laser diffraction/light scattering method), electron microscope (either scanning or transmission method may be used) to grasp a growth degree thereof. Such a structure can efficiently form a conductive path between electrode active material particles. Therefore, excellent conductivity can be imparted to an electrode active material layer with less usage.

### (Organic Dispersing Medium)

On the other hand, as an organic dispersing medium for dispersing a carbonaceous material as described above, there is no special limitation, and it can be selected appropriately according to the purpose of use, etc. of the obtained carbonaceous material dispersion.

Organic dispersing media are not limited, but include, for example, ester solvents such as dibutyl ether, ethyl acetate, ethyl propionate, propyl propionate, butyl propionate, pentyl propionate, hexyl propionate, heptyl propionate, octyl propionate, ethyl butyrate, propyl butyrate, butyl butyrate, pentyl butyrate, hexyl butyrate, heptyl butyrate, octyl butyrate, ethyl valerate, propyl valerate, butyl valerate, amyl valerate, hexyl valerate, heptyl valerate, octyl valerate, ethyl caproate, propyl caproate, butyl caproate, pentyl caproate, hexyl caproate, heptyl caproate, octyl caproate, ethyl heptanoate, propyl heptanoate, butyl heptanoate, pentyl heptanoate, hexyl heptanoate, heptyl heptanoate, octyl heptanoate, etc.; ketone solvents such as diethyl ketone, dimethyl ketone, methyl ethyl ketone (MEK), and methyl isobutyl ketone (MIBK), cyclohexanone (anone) etc.; non-protonic polar solvents such as N,N-dimethylformamide (DMF), N,N-dimethylacetamide (DMAc), N-methyl-2-pyrrolidone (NMP), etc.; alkane solvents such as pentane, cyclopentane, hexane, cyclohexane, heptane, cycloheptane, octane, cyclooctane, nonane, decane, etc.; chained carbonates such as dimethyl carbonate, ethyl methyl carbonate, diethyl carbonate, etc.; cyclic carbonates such as ethylene carbonate, propylene carbonate, etc.; toluene, xylene, benzene, paraxylene, carbon tetrachloride, etc.; which can be used individually or in combination.

Among them, butyl butyrate, xylene, mesitylene, heptane, and the like are particularly preferred.

### (Other Components)

In addition to the carbonaceous material and organic dispersing medium described above, the carbonaceous material dispersion may contain a dispersant, a pH regulator, or other additives. As other additives, in addition to a dispersing aid, a stabilizer, or the like, it is also possible to include, for example, a binder resin, a positively active material or a negatively active material, and the like.

Thus, the method of dehydration of carbonaceous material dispersion can be applied not only to a carbonaceous material slurry containing a carbonaceous material, an organic dispersing medium and a dispersant, but also to other carbonaceous dispersions which contain more components, such as an electrode slurry for all-solid-state lithium-ion secondary battery, which contains more components such as a binder resin and a cathode active material or a negative electrode active material in addition to the carbonaceous material, the organic dispersion medium and the dispersant.

### (Dispersant)

As a dispersant, without special limitation, for example, polyvinyl butyral (PVB), polyvinyl acetal, polyvinyl acetate, polyester resin, epoxy resin, polyether resin, alkyd resin, urethane resin, and the like may be illustrated.

One preferred example of the dispersant is a form in which polyvinyl butyral is the main component, especially more than 80% by mass, and furthermore, the total amount of the dispersant, i.e., 100% by mass, is polyvinyl butyral. When the carbonaceous material dispersion is used for all-solid-state lithium ion secondary battery applications, the use of polyvinyl butyral as a dispersant in this manner, in combination with an organic dispersing medium as described above as a dispersing medium, provides good dispersibility of the carbonaceous material in the carbonaceous material dispersion and enables low viscosity.

As the polyvinyl butyral, there is no particular limitation, but the hydroxyl group content is relatively low, specifically, for example, the hydroxyl group content in the polymer is not less than 5% by mass and not more than 25% by mass, more preferably, not less than 10% by mass and not more than 20% by mass, and further preferably, not less than 12.5% by mass and not more than 17.5% by mass. Also, although not particularly limited, as the acetate group content of the polyvinyl butyral, about 1 to 7% by mass is preferred. As for viscosity, it is preferable that, measured at 20° C., based on DIN53015, the ethanol solution with 10% polyvinyl butyral by mass has a solution viscosity of about 10 to 100 mPa·s, and especially about 20 to 60 mPa·s.

### (pH Regulator)

As the pH regulator, for example, tertiary amines, secondary amines, primary amines, cyclic amines, alkanolamines or amino alcohols as compounds having amino groups and hydroxyl groups in the alkane skeleton, or amine compounds such as diglycol ammonium salt, tris(hydroxymethyl)aminomethane (THAM), morpholine and other amines may be exemplified. Although not particularly limited, 2-methylaminoethanol, 2-amino-1-butanol, 4-ethylamino-1-butanol, triethylamine, 2-amino-2-ethyl-1,3-propanediol (AEPD), 2-amino-2-methyl-1-propanol (AMP) and THAM are particularly preferred.

### (Binder Resin)

In the case where the carbonaceous material dispersion to be treated is an electrode slurry for all-solid-state lithium-ion batteries, the binder resin to be blended in the dispersing medium is not particularly limited, but a polymer that is insoluble in water may be used, specifically, polyvinylidene fluoride, polytetrafluoroethylene, polyimide, polyamide, polyamideimide, butadiene rubber, isobutylene rubber, styrene-butadiene rubber, ethylene-propylene rubber, nitrile rubber and the like may be used. The styrene butadiene rubber is preferably used.

### (Electrode Active Material)

In the case where the carbonaceous material dispersion to be treated is an electrode slurry for all-solid-state lithium-ion batteries, the cathode active material to be blended in the dispersing medium is not particularly limited, and metal oxides, metal compounds such as metal sulfides and conductive polymers that can dope or intercalate lithium ions may be used.

For example, examples include oxides of transition metals such as Fe, Co, Ni and Mn, complex oxides with lithium, inorganic compounds such as transition metal sulfides, and the like. Specifically, there are transition metal oxide powders such as MnO, V₂O₅, V₆O₁₃, and TiO₂, composite oxide powders of lithium and transition metals such as lithium nickelate, lithium cobaltate, lithium manganate, and lithium manganate with spinel structure, ferrous lithium phosphate-based materials as phosphate compounds with olivine structure, and transition metal sulfide powders such as TiS₂ and FeS. In addition, conductive polymers such as polyaniline, polyacetylene, polypyrrole and polythiophene may also be used. In addition, the above-mentioned inorganic compounds and organic compounds may be used in combination.

In the case where the carbonaceous material dispersion to be treated is an electrode slurry for all-solid-state lithium-ion batteries, the anode active material to be blended in the dispersing medium is not particularly limited, as long as lithium ions can be doped or intercalated. For example, examples include metal Li, alloy systems such as tin alloy, silicon alloy and lead alloy, metal oxide systems such as Li_{X}Fe₂O₃, Li_{X}Fe₃O₄, Li_{X}WO₂, lithium titanate, lithium vanadate and lithium silicate, conductive polymer systems such as polyacetylene and poly-p-phenylene, amorphous carbonaceous materials such as soft carbon and hard carbon, artificial graphite such as graphitized carbonaceous material, or carbonaceous powder such as natural graphite, carbon black, mesophase carbon black, resin sintered carbonaceous material, vapor-grown carbon fiber, carbon fiber and other carbonaceous materials. These anode active materials may also be used in one form or in combination.

The average particle size of these electrode active materials is preferably in a range of 0.05 to 100 μm, more preferably in a range of 0.1 to 50 μm. The average particle size of the electrode active material mentioned in this specification refers to the average particle size measured by an electron microscope.

### (Mixing Proportion in the Dispersion)

Although there is no particular limitation, in the carbonaceous material dispersion to be treated, the carbonaceous material may be adjusted to be 10 to 25% by mass, more preferably 12 to 18% by mass, with respect to the total mass of the dispersion, in the organic dispersing medium. In addition, in the case that a dispersing agent is added, the amount of the dispersing agent is not particularly limited, but may be adjusted to be, for example, not less than 5% by mass and not more than 20% by mass, preferably not less than 6% and less than 12% by mass of the carbonaceous material (i.e., assuming the total mass of the carbonaceous material is 100%). If the masses of the carbonaceous material and the dispersing agent are kept within these ranges, it is possible to form a dispersion containing a high concentration of carbonaceous material while maintaining good dispersibility and low viscosity of the carbonaceous material. In addition, if the concentration of the carbonaceous material is less than the above proportion, energy required for removing the solvent in manufacturing the product may increase, and a transportation cost of the dispersion and a cost of the solvent may increase.

In addition, as described above, when the pH regulator is mixed, an added amount of the pH regulator is set to be 0.01 to 5%, more preferably about 0.05 to 3%, relative to the total amount of the dispersion. By adding the pH regulator within this range, a better dispersibility of the carbonaceous materials can be obtained.

### (Characterization of Dispersions of Carbonaceous Materials as Substances to be Treated)

Furthermore, there is no particular limitation on the carbonaceous material dispersion obtained by applying the dispersion treatment as exemplified below, for example, for the composition and the blended amount of the composition as described above, but the viscosity may be 10 to 1,000 mPa·s, preferably 10 to 500 mPa s, and even more preferably about 10 to 300 mPa·s under the condition of 25° C. When the carbonaceous material dispersion described above includes a binder resin and an electrode active material in order to constitute the electrode slurry for all-solid lithium-ion secondary batteries, the viscosity may range from 500 to 5000 mPa·s, preferably, from 1000 to 4000 mPa·s under the condition of 25° C. This viscosity is achieved due to the solid component concentration of the slurry, which is between 65 to 75% by mass using the specified components.

It should be noted that in this specification, the viscosity of the carbonaceous material dispersion is the value measured by a B-type viscometer immediately after the dispersion is fully stirred by a spatula (for example, for one minute) at a measuring temperature of 25° C. and a rotor speed of the B-type viscometer of 60 rpm.

In addition, there is no particular limitation as to the water content in the carbonaceous material dispersion as the material to be treated (i.e., prior to treatment utilizing the water removal method of the present invention), e.g., about 1×10⁻³ to 2×10⁻² in terms of mass fraction, and more preferably about 1×10⁻³ to 1×10⁻².

### (Preparation of Carbonaceous Material Dispersion as a Substance to be Treated)

The method of preparing a carbonaceous material dispersion as a substance to be treated is not particularly limited. The carbonaceous material dispersion may be prepared by adding a carbonaceous material, and a dispersant, a pH adjuster, or other ingredients as desired, to an organic dispersing medium in the ratio specified above, stirring and mixing, and then dispersing it. It should be noted that there is no particular limitation on the order of addition of the components thereof, etc., and that any method is included in the scope of the present invention.

A dispersion device is not particularly limited, and a dispersion machine commonly used for pigment dispersion and the like may be used. For example, mixers such as dispersers, homogenizers and planetary mixers, homogenizers (“CLEARMIX” manufactured by M-Technical, “FILMICS” manufactured by PRIMIX, “ABRAMIX” manufactured by Silverson), paint regulator (manufactured by Red Devil), paint mixers (“PUC Paint Mixer” manufactured by PUC, and “paint mixer MX” manufactured by IKA), cone mill (“cone mill MKO” manufactured by IKA), ball mills, sand mills (“Dyno mill” manufactured by Shinmaru Enterprises), grinders, bead mill (“DCP mill” manufactured by Eirich), sand mills and other medium dispersion machines, wet jet mills (“GenusPY” manufactured by Genus, “Star Burst” manufactured by Sugino Machine, “Nanomizer” manufactured by Nanomizer, and the like), “CLEAR SS-5” manufactured by M-Technic, “MICROS” manufactured by Nara Machinery, and other roller mills, may be enumerated, although the dispersion device is not limited to this enumeration.

Preferably, the carbonaceous material is finally dispersed and prepared by a medium mill, especially the medium mill using beads with an average particle size of 0.05 to 2 mm. More preferably, before the dispersion treatment by the medium mill, the dispersion treatment is carried out by using a shearing type dispersion device described in detail below, and then the dispersion treatment is carried out by the medium mill, thereby completing the preparation.

In addition, before the dispersion treatment by the medium mill, pre-dispersion treatment may be carried out by using other stirring devices, such as a shearing mixer such as a disperser and a homogeneous mixer.

Although it is not limited, it is possible to dehydrate each component used prior to the preparation of carbonaceous material dispersion by any known method, such as dehydration using adsorbents such as ion exchange resins, zeolites, molecular sieves, alumina particles, phosgene compounds and metal oxides, distillation dehydration or azeotropic dehydration, and dehydration by heating, for example.

### (Method for Manufacturing Low-Moisture Carbonaceous Material Dispersions)

The method for manufacturing a carbonaceous material dispersion according to the second aspect of the present invention is a method for manufacturing a carbonaceous material dispersion in which carbonaceous material particles are dispersed in an organic dispersing medium, comprising, for example, after the carbonaceous material dispersion preparation process as described above being carried out and carbonaceous material particles being added and dispersed in the organic dispersing medium to produce a carbonaceous material dispersion, blowing a dry inert gas into the dispersion, at a ratio of 6 to 30 L of the inert gas relative to 100 g of the dispersion while maintaining the dispersion at 20 to 120° C., and thereby, bringing the dispersion into contact with the dry inert gas to evaporate the water in the dispersion, similar to the method for removing water of the first aspect of the invention detailed above.

In the method for manufacturing a carbonaceous material dispersion of the second aspect of the present invention, the same can be applied to the various conditions, and in particular, the preferred conditions, related to the method for removing water of the first aspect of the present invention described in detail above, and therefore, in order to avoid repetition, the further description is omitted herein.

Furthermore, in the method for manufacturing the carbonaceous material dispersion of the second aspect of the present invention, there is no special restriction on the process other than the above-described water evaporation process, for example, the preparation process of the carbonaceous material dispersion prior to the water evaporation process may be employed in a variety of ways without being limited to the above-described preparation process. Furthermore, in the method for manufacturing the carbonaceous material dispersion of the second aspect of the present invention, the process for evaporating water mentioned above is necessary from the aspect of removing or dehydrating water, but it is arbitrary to set up a treatment or process other than the above, e.g., an organic dispersion medium and carbonaceous material, etc., which are used as the material for the carbonaceous material dispersion to be disposed of, can be set up to perform a separate treatment in the process for evaporating the above water, such as dehydration treatment or drying treatment. For example, in the process of evaporating water as described above, the organic dispersion medium and the carbonaceous material which are materials for the carbonaceous material dispersion to be treated can also be provided with a separate process such as a dehydrating process or a drying process.

### EXAMPLE

Hereinafter, the present invention is described more concretely based on embodiments. However, the present invention is not limited to the following examples as long as they do not deviate from the scope of the present invention.

### (Preparation of Carbonaceous Material Dispersion a for Testing)

First, when implementing Examples 1 to 3 and Comparative Examples 1 to 4 below, a carbonaceous material dispersion A for use as a test material was prepared as follows, i.e., 300 g of acetylene black dispersion as a carbonaceous material dispersion for testing was prepared by dispersing in a bead mill in the ratio of 15 parts by mass of acetylene black, 84 parts by mass of butyl butyrate as a dispersing medium, and 1 part by mass of polyvinyl butyral as a dispersing agent. The water content of the test carbonaceous material dispersion was 2.056×10⁻³ in terms of mass fraction, and the non-volatile content was 16.00% by mass.

The water content (mass fraction) was measured using a Karl Fischer moisture titrator and the non-volatile content was measured by weight of a residue after drying at 140° C.

Then, dehydrating was performed to reduce the carbonaceous material dispersion A for testing to a water mass fraction of less than 3.0×10⁻⁵.

### Example 1

Using the apparatus schematically shown in FIG. 1, 100 g of the above-prepared carbonaceous material dispersion A (10) for testing was loaded into a 300 ml flask (40) and stirred with stirrers (30, 32). The dispersion was heated to 60° C. with a heating jacket (42), and dehydrated by blowing dry nitrogen (20) from the bottom of the dispersion at a flow rate of 0.1 L/min for 150 min (15 L in total).

The results showed that the water content of the dehydrated carbonaceous material dispersion was 2.9×10⁻⁵ in terms of mass fraction, and the nonvolatile content was 16.05% by mass.

### Example 2

As in Example 1, using the apparatus schematically shown in FIG. 1, 100 g of the above-prepared dispersion A of carbonaceous material for testing (10) was loaded into a 300 ml flask (40), depressurized in the system so that it was lower than −50 kPa compared to the atmospheric pressure, and stirred with stirrers (30, 32). The dispersion was heated to 40° C. with a heating jacket (42) and dehydrated by blowing dry nitrogen (20) from the bottom of the dispersion at a flow rate of 0.1 L/min for 120 min (12 L in total). The results showed that the water content of the dehydrated carbonaceous material dispersion was 2.2×10⁻⁵ in terms of mass fraction, and the nonvolatile content was 16.2% by mass.

### Example 3

100 g of the above-prepared carbonaceous material dispersion A (10) for testing was loaded into a 300 ml flask (40), and the dispersion was heated up to 40° C. with a heating jacket (42). In this embodiment, the stirrers (30, 32) were not configured. A diffuser (not shown) comprising sintered glass was provided at the bottom of the flask (40) at the front end of the blowing nozzle 24 of the inert gas. Dry nitrogen (20) was blown in from the bottom of the dispersion (10) at a flow rate of 0.1 L/min for 120 minutes (totaling 12 L) to carry out the dehydration process. The number of bubbles of dried nitrogen exported from the diffuser into the dispersion at this time had a number average particle diameter of 2 mm. The results showed that the water content of the dehydrated carbonaceous material dispersion was 2.8×10⁻⁵ in terms of mass fraction and the nonvolatile content was 16.02% by mass.

### Comparative Example 1

Dehydration was carried out in the same manner as in Example 1 except that the dispersion was kept at 10° C. in Example 1. The results showed that the water content of the treated dispersion of carbonaceous material was 6.0×10⁻⁴ in terms of mass fraction and the nonvolatile content was 16.00% by mass.

### Comparative Example 2

Dehydration treatment was carried out in the same manner as in Example 1 except that the dispersion was kept at 130° C. in Example 1. The results showed that the dispersions agglomerated and the dispersions solidified during the treatment.

### Comparative Example 3

Dehydration was carried out in the same manner as in Example 1 except that in Example 1 the blow-in volume of drying nitrogen (20) was set at a flow rate of 0.1 L/min for 50 min (5 L in total). The results showed that the water content of the treated carbonaceous material dispersion was 1.1×10⁻⁴ in terms of mass fraction, and the nonvolatile content was 16.00% by mass.

### Comparative Example 4

Dehydration was carried out in the same manner as in Example 1 except that the blow-in amount of dry nitrogen (20) in Example 1 was set to 360 min (36 L in total) at a flow rate of 0.1 L/min. The results showed that the water content of the treated carbonaceous material dispersion was 7.0×10⁻⁶ in terms of mass fraction, and the nonvolatile content was 16.85% by mass.

### (Preparation of Carbonaceous Material Dispersion B for Testing)

When implementing Example 5 below, a carbonaceous material dispersion B for testing, which is assumed to be an all-solid electrode slurry for lithium-ion secondary batteries, was prepared as follows, i.e., to 10.0 g of the carbonaceous material dispersion A for testing prepared as described above, 30.0 g of LiNi_{1/3}Co_{1/2}Mn_{1/3}O₂ powder (manufactured by FUJIFILM Wako Pure Chemical Corporation, particle diameters range from 1 μm to several μm) as the cathode active material, and a binder solution of 10% by mass of styrene butadiene rubber dissolved in butyl butyrate were blended to obtain a total solid component concentration of 65% by mass, and processed for 5 minutes using a revolution-rotation planetary centrifugal mixer at a speed of 1200 rpm for both revolution and rotation. The water content of the obtained carbonaceous material dispersion B for testing was 1.5×10⁻³ in terms of mass fraction and the nonvolatile content was 65.00% by mass. The water content and the nonvolatile content were measured in the same way as described above. Then, dehydrating was performed to reduce the carbonaceous material dispersion B for testing to a water mass fraction of less than 3.0×10⁻⁵.

### Example 5

As in Example 1, 100 g of the above-prepared carbonaceous material dispersion B for testing (10) was loaded into a 300 ml flask (40) and stirred with a stirrer (30, 32) using the apparatus schematically shown in FIG. 1. The slurry was heated to 60° C. with a heating jacket (42), and dehydrated by blowing dry nitrogen (20) from the bottom of the slurry at a flow rate of 0.1 L/min for 150 min (15 L in total). The results showed that the water content of the dehydrated slurry was 2.8×10⁻⁵ in terms of mass fraction, and the nonvolatile content was 65.08% by mass.

### DESCRIPTION OF SYMBOLS

10 Carbonaceous material dispersions
20 Dry Nitrogen
24 Blowing nozzle
30, 32 Stirrers
40 Flask
42 Heating jacket

1. A method for dehydrating carbonaceous material dispersion in which carbonaceous material particles are dispersed in an organic dispersing medium, comprising:
blowing a dry inert gas into the dispersion, at a ratio of 6 to 30 L of the inert gas relative to 100 g of the dispersion while maintaining the dispersion at 20 to 120° C., and thereby, bringing the dispersion into contact with the dry inert gas to evaporate the water in the dispersion.

2. The method for dehydrating carbonaceous material dispersion according to claim 1, wherein the carbonaceous material dispersion is stirred while blowing the inert gas through it, and the inert gas is blown from a bottom side of a container that contains the carbonaceous material dispersion.

3. The method for dehydrating carbonaceous material dispersion according to claim 1, wherein bubbles with an average size ranging from 5 mm to 0.5 mm are generated in the carbonaceous material dispersion by blowing said inert gas into the dispersion.

4. The method for dehydrating carbonaceous material dispersion according to claim 1, wherein a pressure in a system is reduced to −5 kPa to −95 kPa in comparison to atmospheric pressure, when blowing said inert gas in the dispersion.

5. The method for dehydrating carbonaceous material dispersion according to claim 1, wherein the gas in the dispersion is degassed by reducing the pressure, after blowing said inert gas in the dispersion.

6. The method for dehydrating carbonaceous material dispersion according to claim 1, wherein the organic dispersing medium is at least one selected from the group consisting of an ester solvent, a ketone solvent, a hydrocarbon solvent, and mixtures thereof.

7. The method for dehydrating carbonaceous material dispersion according to claim 1, wherein the organic dispersing medium is at least one selected from the group consisting of butyl butyrate, xylene, mesitylene, and heptane.

8. The method for dehydrating carbonaceous material dispersion according to claim 1 wherein said carbonaceous material is carbon black.

9. The method for dehydrating carbonaceous material dispersion according to claim 1, wherein said inert gas is nitrogen.

10. The method for dehydrating carbonaceous material dispersion according to claim 1, wherein said inert gas has a dew point of −50° C. or less.

11. The method for dehydrating carbonaceous material dispersion according to claim 1, wherein said carbonaceous material dispersion comprises a carbonaceous material, an organic dispersing medium, and a dispersant.

12. The method for dehydrating carbonaceous material dispersion according to claim 1, wherein said carbonaceous material dispersion is an electrode slurry for an all-solid lithium-ion secondary battery comprising a carbonaceous material, an organic dispersing medium, a dispersant, a binder resin, and a cathode active material or an anode active material.

13. The method for dehydrating carbonaceous material dispersion according to claim 1, wherein a change in a non-volatile component of the dispersion before and after contacting the dispersion with the dry inert gas to evaporate the water in the dispersion is not more than 0.5% by mass, and the water content of the dispersion after the contacting is not more than 5×10-5 in terms of mass fraction.

14. A method for manufacturing a carbonaceous material dispersion for dispersing carbonaceous material particles in an organic dispersion medium, comprising:
adding carbonaceous material particles to an organic dispersion medium and dispersing them to make a carbonaceous material dispersion, and
blowing a dry inert gas into the dispersion, at a ratio of 6 to 30 L of the inert gas relative to 100 g of the dispersion while maintaining the dispersion at 20 to 120° C., and thereby, bringing the dispersion into contact with the dry inert gas to evaporate the water in the dispersion.

15. A method for manufacturing a carbonaceous material dispersion according to claim 14, wherein said carbonaceous material dispersion comprises a carbonaceous material, an organic dispersion medium, and a dispersant.

16. The method for manufacturing a carbonaceous material dispersion according to claim 14, wherein said carbonaceous material dispersion is an electrode slurry for an all-solid lithium-ion secondary battery comprising a carbonaceous material, an organic dispersing medium, a dispersant, a binder resin, and a cathode active material or an anode active material.
